(19) United States
(12) Patent Application Publication
(10) Pub. No.: US 2025/0179333 A1
(43) Pub. Date: Jun. 5, 2025

(54) FLAME RESISTANT AND THERMALLY CONDUCTIVE STRUCTURAL ACRYLIC ADHESIVE

(71) Applicant: Illinois Tool Works Inc., Glenview, IL (US)

(72) Inventors: Deric Greger, Glenview, IL (US); Srihith Bhamidipati, Glenview, IL (US); Jeff Gasa, Glenview, IL (US)

(73) Assignee: Illinois Tool Works Inc., Glenview, IL (US)

(21) Appl. No.: 18/960,539

(22) Filed: Nov. 26, 2024

Related U.S. Application Data
(60) Provisional application No. 63/604,362, filed on Nov. 30, 2023.

(51) Int. Cl. C09J 4/06; C08K 3/105; C08K 3/34; C08K 5/00; C08K 5/42; C09J 5/00; C09J 133/12

(52) U.S. Cl. CPC C09J 4/06; C08K 3/105; C08K 3/346; C08K 5/0091; C08K 5/42; C09J 5/00; C09J 133/12; C08K 2201/001; C08K 2201/005

(57) ABSTRACT

A process of applying an adhesive to a substrate is provided that includes the mixing together of the components of a two-part formulation of a Part A and a Part B. The Part A and Part B each independently include a methacrylate monomer, and a conductive filler. The formulation additionally includes an impact modifier, an organometallic catalyst, powdered rheology and a thixotrope, and a peroxide catalyst present in at least one of said Part A and said Part B or added thereto as additional components. The A and B Parts are combined together to form a thermally conductive adhesive mixture. The adhesive mixture is applied to the substrate. A formulation for the Part A and B is also provided. A bonded structure is provided in which the adhesive so created is intermediate between a first substrate and a second substrate.

### RELATED APPLICATIONS

This application claims priority benefit of U.S. Provisional Application Ser. No. 63/604,362 filed Nov. 30, 2023; the contents of which are hereby incorporated by reference.

### FIELD OF THE INVENTION

The present invention in general relates to adhesives, and in particular, to free-radical curing adhesives with strength maintenance after heating with properties of flame resistant, low toxicity, and highly thermally conductive compared to conventional products.

### BACKGROUND OF THE INVENTION

In many industries, manufacturers of mated components have changed to structural adhesives to replace conventional fastening techniques such as rivets, bolts, and welding. Adhesives in theory offer many attractive properties that include improved product performance, aesthetics, some reduced overall assembly time, and lower production costs. Additionally, adhesives preclude much of the stress point concentration, corrosion, and component damage often seen with rivets, bolts, welding, and other traditional fastening methods. Adhesives have made considerable progress in lowering assembly times versus some traditional mechanical fastening methods but depending on the application and assembly time can still suffer from detrimental effects due to work life of the adhesive. In many applications, if the assembly has not been completed before the material becomes a hard or gelled solid, the adhesive joint will not offer the strength needed to perform as designed. In many instances if this happens it can lead to expensive and time-consuming reworking costs. To mitigate these problems manufacturers can go to a material with longer work life. However, in proceeding this way the material will take a longer time to become of sufficient strength to move to the next step in an assembly which is known as “fixture time.” Typically, for adhesives, as the work life is increased the fixture time can increase dramatically.

A sufficient strength to move to the next step in the production process is known as the fixture time for an adhesive. The adhesive strength to move to another stage in a production process is problematic since it is very much dependent on the specifics of the production process and the product. Most often, bond strengths to a metal joint are used to define adhesive strength. American standard test method, ASTM D1002, “Standard Test Method for Apparent Shear Strength of Single-Lap-Joint Adhesively Bonded Metal Specimens by Tension Loading (Metal-to-Metal)” is a well-accepted standard for testing adhesive strength. Fixture time can be defined as the time of the adhesive to reach a defined adhesive strength.

Typically, acrylic adhesives are used in applications where fixture time or time until the part can be handled is critical in a production or repair. Fixture time can typically be improved by accelerating the adhesive with a catalyst, increasing curing agent, or reducing agent. However, in doing this, the work life, or time in which the material can be applied, is also reduced. If the work life is too short, the adhesive may be wasted, and the mating parts may not be properly adhered to each other. If the time to when the part can be handled, fixture time, is too long, repair or production time can be lost.

In the automotive industry, metal adhesive bonding generally includes steps such as a thorough cleaning of mating surfaces of the substrates, light sanding of the bonding surfaces, and use of an adhesion promoter and/or a primer. These steps are performed to make the surface of the substrates as receptive as possible to the adhesive. Contaminants left on the surface can reduce bond strength by interfering with the adhesive's ability to form a bond, producing a weaker chemical bond, or reduced bond area. Furthermore, the contaminant may provide a fracture initiation site when the bond is stressed, again reducing the load the joint can withstand. Therefore, the cleaning step to remove possible contaminants from a boding surface is generally required to ensure a good adhesive bond. Sanding surfaces removes gross surface imperfections, facilitating a bondline of consistent thickness and intimate contact between the adhesive and substrate. Priming can be an actual coating of another layer that provides a more consistent and bondable surface. An adhesion promoter can be used that “activates” the surface, providing chemical groups ready to latch onto the adhesive when applied. These preparations happen before paint is applied in an automotive factory, but not before applications such as hem flange bonding.

Hem flange bonding is performed before painting in a body shop of an assembly plant or at a metal fabrication plant and shipped to the assembly plant. The steel body panels, usually galvanized, are stamped and formed, processing which requires various lubricants to be applied, such as mill oils and drawing compounds, or pre-lubes. One or more of these lubricants may be present when the adhesive is applied, however no cleaning step to remove the lubricant occurs, partly because the lubricant also functions to prevent oxidation of the metal.

During hem flange bonding, after the adhesive is applied to an outer panel, an inner panel is positioned and the outer panel is bent or crimped around the inner panel, forming the hem flange. Bead size of the adhesive is carefully controlled to fill the bondline but to avoid squeeze out. Adhesives that escape the bondline may contaminate the equipment and cause cleanliness and maintenance issues in the manufacturing plant. A cure step may be introduced at this stage, such as induction curing. The cure step may be a full cure or just enough to prevent any movement of inner to outer panel during subsequent processing. The body closure panels are attached to the frame and sent to the paint shop where it is cleaned, primed, and painted. Cure of the adhesive is completed in the paint ovens.

One of the reasons for using an adhesive in the hem flange is to reduce or eliminate the use of spot welds to hold the inner and outer panels together. Spot welding is sometimes noticeable on the outer panel, necessitating a finishing or polishing step prior to painting to make the spot weld virtually invisible. The few remaining spot welds act as peel stoppers, reducing the susceptibility of the adhesive to any peel loads, and hold the panels together until the adhesive is cured. This processing step has brought new requirements to the adhesive related to weldability. First, the adhesive must not interfere with the integrity of the spot weld. Second, similar to the forming process, the adhesive must not escape the joint and get on the welding equipment.

With the further use of adhesives in manufacturing there is a demand for improved adhesive formulations that are suitable to bond metal substrates and be subjected to various finishing processes including painting, electric coating (E-Coat)/electrostatic painting, and powder coat post bake. There is a further concern with existing adhesives as to flammability that complicates industrial handling and usage thereof.

Electrostatic painting of various vehicle components presents an attractive and cost effective scheme as compared to usage of a conventional paint line. Electrostatic painting of vehicle parts, such as doors, hoods, quarter panels, and other vehicle skin parts can be routinely performed. Owing to the high visibility and environmental exposure encountered by such vehicle parts, a high quality paint finish surface is demanded with a high degree of reflectivity and a surface free of visual defects. Electrostatic painting requires the part to be electrically conductive and support an electrical potential on the part needed to attract oppositely charged paint aerosol droplets to the part. Therefore, bonding adhesives used to join parts that are subject to painting are generally required to be conductive to ensure that bonded pieces are charged at the same potential during a painting stage.

Furthermore, in general, polymer compositions are less thermally conductive than metals so any heat generated in these materials cannot be easily dissipated to the surroundings. As such, there is a need to increase the thermal conductivity of acrylic adhesives. There is a further need to ensure that such thermally conductive acrylic adhesives are non-toxic and non-flammable in order to reduce potential health risks for users of the adhesives and to promote shelf storage stability.

Thus, there exists a need for a structural adhesive formulation which can be used to increase work life while mitigating the extension of fixture time while being suitable for various finishing processes. There is a further need for structural adhesive formulations that are thermally and/or electrically conductive so as to bond parts that provide surfaces that are amenable to receiving a highly uniform paint coating via electrostatic painting techniques and capable of dissipating heat to the surrounding environment. There is a further need to ensure that such thermally conductive acrylic adhesives are low toxicity and flame resistant in order to reduce potential health risks for users of the adhesives and to promote shelf storage stability.

### SUMMARY OF THE INVENTION

A process of applying an adhesive to a substrate is provided that includes the mixing together of the components of a two-part formulation of a Part A and a Part B. The Part A and Part B each independently include a methacrylate monomer and a conductive filler. The formulation additionally includes an impact modifier, an organometallic catalyst, and a peroxide catalyst present in at least one of the Part A and the Part B or added thereto as additional components. The A and B Parts are combined together to form a thermally conductive adhesive mixture. The adhesive mixture is applied to the substrate. A formulation for the Part A and B is also provided. A bonded structure is provided in which the adhesive so created is intermediate between a first substrate and a second substrate.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a graph showing ASTM D1002 lap shear testing of an inventive adhesive formulation including 85% thermally conductive filler applied and cured between two aluminum substrates;

FIG. 2 is a graph showing ASTM D1002 lap shear testing of an inventive adhesive formulation including 75% thermally conductive filler applied and cured between two aluminum 6006 substrates;

FIG. 3 is a graph showing ASTM D1002 lap shear testing of an inventive adhesive formulation including 85% thermally conductive filler applied and cured between two aluminum 6006 substrates;

FIG. 4 is a graph showing ASTM D1002 lap shear testing of an inventive adhesive formulation including 85% thermally conductive filler applied and cured between two SS304 substrates; and

FIG. 5 is a graph showing the testing results of dynamic mechanical analysis (DMA) tests conducted on an inventive adhesive formulation including 85% thermally conductive filler.

### DETAILED DESCRIPTION OF THE INVENTION

The present invention has utility as a curing adhesive particularly well suited for bonding structural substrates. Structural substrates operatively bonded by an inventive adhesive may include electrogalvanized steel, hot-dipped galvanized steel, cold-rolled steel, aluminum, aluminum alloys, polyacrylonitrilebutadiene-styrene (ABS), mild steel (MS), polyvinyl chloride (PVC), and fiberglass. An inventive adhesive formulation is appreciated to be operative to bond to like structural substrates, as well as to bond one such substrate to other substrates including other metals, other plastics, and to do so through a rapid handling strength during cure to facilitate handling and removal of fixturing devices in a manufacturing setting. Thermally conductive fillers are incorporated in the adhesive formulation to control thermal conductivity of the high temperature adhesive. The inclusion of thermally conductive fillers in embodiments of the high temperature adhesive provides a conductive adhesive that improves thermal transfer between bonded cured materials that is advantageous for heat dissipation.

As used herein, thermally conductive portion is defined as being between 0.1 and 2000 (W/m·K) above that for a cured material devoid of thermally conductive fillers; and is routine measured by hot disk method bulk scan with a 5 mm probing depth.

As used herein, “V0” and “V1” refer to fire retardant classifications under the UL 94 standard, where “V0” indicates a higher level of fire resistance, meaning a cured material will self-extinguish within 10 seconds when exposed to a flame, while “V1” means it will self-extinguish within 30 seconds; with both classifications being tested on a vertical specimen and do not allow flaming drips to ignite a cotton cloth there below.

Embodiments of the inventive adhesive formulation are based on a methacrylate monomer of benzyl methacrylate, methyl methacrylate, isobornyl methacrylate, methacrylic acid, tetrahydrofurfuryl methacrylate (THFMA), tetrahydrofurfuryl acrylate (THFA), 2-hydroxyethyl methacrylate phosphate (HEMA) phosphate, 2-hydroxypropyl methacrylate (HPMA), lauryl methacrylate or a combination thereof. Embodiments of the inventive adhesive formulation have a 1:1, 4:1, or 10:1±0.10% mix ratio that are convenient for users and provides excellent adhesion to high contaminated metal surfaces, even when associated with cutting and sampling-oils, and in some embodiments without using a primer. Embodiments of the inventive adhesive formulation are suitable to bond metal substrates and may be subjected to various processes including painting, and heating to temperatures of up to 205° C. (400° F.) without detrimental effects on adhesion or physical performance owing the loadings of thermally conductive filler therein. Embodiment of the inventive adhesive formulation are well suited for bonding hem flange joints on metal components such as doors on various vehicles, and also provides the ability to be manipulated to afford various work times to accommodate other transportation and general industrial applications.

Embodiments of the inventive formulation contain inhibitors, antioxidants, and stabilizers that help increase work life while mitigating the extension of fixture time. Without intending to be bound to a particular theory through agent selection the fixture time and work time properties are believed to be a result of a combination of thermodynamically and kinetically controlled processes.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

For the purpose of definition and defining a strength that is considered adequate for most production assemblies, fixture time as used herein is the time to reach the strength of 1 MPa as measured per ASTM D1002 with a half-inch overlap using a bond gap of 0.03 inches.

As used herein, work life is defined as the time for the material to reach a state of gel as defined by a point in time after the material is first mixed when the storage modulus (G′) and the loss modulus (G″) are equal as defined by dispensing a bead of the material (˜20 grams) from a cartridge and through a tip mixer and then preform a manual check with a tongue depressor the time it takes for the adhesive to start thickening.

As used herein, maintenance with respect to adhesive strength at elevated temperature is defined as the tensile strength being within 20% of the room temperature strength measured immediately after cure.

This invention uses an acrylic adhesive in a two-part adhesive formulation. It is provided as a binary system including an adhesive part A and an activator part B. The part A includes the methacrylate monomer of: benzyl methacrylate, methyl methacrylate, isobornyl (meth) acrylate, methacrylic acid, tetrahydrofurfuryl methacrylate (THFMA), tetrahydrofurfuryl acrylate (THFA), 2-hydroxyethyl methacrylate phosphate (HEMA) phosphate, 2-hydroxypropyl methacrylate (HPMA), lauryl methacrylate or a combination thereof, as a monomer; and a conductive filler. In some inventive embodiments, a pre-reacted elastomer rubber or a reactive liquid polymer (RLP) is also present in Part A. The part B includes the part A methacrylate monomer, which according to embodiments is a high flash point acrylate monomer; and a conductive filler, with the proviso that an impact modifier, an organometallic catalyst, powdered rheology and thixotropic additives, and a peroxide catalyst are each present in a fully mixed curable formulation as separate parts or in at least one of part A or part B. In some embodiments, the part B methacrylate monomer is the same monomer or combination of monomers present in part A. In still other inventive embodiments, a pre-reacted elastomer rubber or a reactive liquid polymer (RLP) is also present in Part B. Optionally, in at least one of part A and part B, a free-radical polymerization inhibitor, a toughening agent, an adhesion promoter, an antioxidant, a polymerization accelerator, additives, or a combination thereof are present in the formulation.

Various additives are readily included to improve the handling properties of an inventive formulation. While the present invention is detailed herein with respect to a 4:1 by weight ratio mixture of Part A:Part B, it is appreciated that other mix ratios are readily compounded ranging from 1:1 to 10:1±10% of Part A:Part B without departing from the spirit of the present invention. Components common to both parts A and B, such as a monomer reactant, filler, antioxidant, elastomer rubbers, and additives can be the same in both parts or different compounds present to impart the desired property to the resulting adhesive.

In some inventive embodiments, part B is devoid of polymerizable monomer and includes a peroxide catalyst; and optionally at least one of a plasticizer, impact modifier, and a thermally conductive filler. The resulting formulation is well suited to form a 10:1±10% ratio of Part A:Part B.

A process of applying an adhesive to a substrate is provided that includes combining together Parts A and B to form an adhesive mixture and applying the mixture to the substrate and allowing the applied mixture to cure.

According to embodiments, the methacrylate monomer includes secondary monomers that are present up to 10 monomer percent by weight of the total combined amount of methacrylate monomer present. A typical lower limit when present is 1 monomer percent by weight, if present. Secondary monomers operative herein illustratively include: lauryl methacrylate, hydroxyethyl methacrylate (HEMA), 2-ethylhexyl methacrylate, trimethylol propane trimethacrylate, benzyl 2-methylpent-2-enoate, benzyl (E)-2-methylhex-2-enoate, benzyl (2E)-2-ethenylpenta-2,4-dienoate, 5-O-benzyl 1-O-methyl (E)-pent-2-enedioate, benzyl (E)-2-methyl-4-prop-2-enoxybut-2-enoate, benzyl prop-2-enoate, methyl (E)-2-methylidene-9-phenylmethoxynon-3-enoate, benzyl (E)-3-methoxy-2-methylprop-2-enoate, ethyl 2-methyl-5-phenylmethoxypent-2-enoate, benzyl (2E)-2-methylhexa-2,5-dienoate, 4-phenylmethoxybutyl 2-methylprop-2-enoate, benzyl (2E,4E)-5-fluoro-2-methylhexa-2,4-dienoate, benzyl (2E)-2-ethenyl-3-methylpenta-2,4-dienoate, fluoro benzyl methacrylate, 2-(perfluorooctyl)ethyl acrylate, (perfluoroheptyl)methyl methacrylate, 2-(N-ethylperfluorooctasulfoamido)ethyl acrylate, 2-(perfluorohexyl)ethyl methacrylate, 2-(perfluoroisononyl)ethyl acrylate, or a combination thereof. Typical loadings of the methacrylate monomer in Part A of the inventive adhesive range from 7-15 total weight percent and in Part B range from 8-16 total weight percent.

The thermally conductive filler operative in the present invention illustratively includes expanded graphite, coke graphite, flake graphite, synthetic graphite, hexagonal boron nitride, zinc oxide, magnesium oxide, aluminum oxide (spherical, roundish, tabular), silane treated, and non-silane treated aluminum oxide, aluminum hydroxide, alumina, alumina trihydrate (ATH), aluminum nitride (AlN), Al₂O₃/hexagonal boron nitride (HBNNT), and combinations thereof. Factors relevant in the choice of a particulate filler illustratively include filler cost, resultant viscosity of flow properties, resultant shrinkage, surface finish weight, flammability, and chemical resistance of the thermoset formulation. Typical filler sizes are from 0.01 to 130 microns. Typical loading of particulate filler in an inventive formulation is from 70 to 90 total weight percent in a 4:1 adhesive:activator formulation. It is appreciated that some of these thermally conductive fillers also afford fire retardancy properties and if also noted as a body filler, the amount of the body filler is subsumed within the stated amount of the thermally conductive filler.

In some inventive embodiments, ATH at 40 total weight % of a cured material can achieve V0 fire retardancy, yet cannot produce thermal conductivity >0.8 w/m*k without the additional loadings of other thermally conductive fillers that illustratively include Al₂O₃, AlN, or a combination thereof.

In some inventive embodiments, the thermally conductive filler has a bimodal size distribution or a second of the aforementioned thermally conductive filler is size matched to promote interstitial filling of voids between proximal particles of filler by the smaller particles of thermally conductive filler. By way of example, four coplanar 18 micron filler particles packed in an matrix formed from an inventive composition create a 7.4 micron diameter interstice. A smaller filler particle having a mean 5 micron diameter is well suited to fill a 7.4 micron interstitial. One of skill in the art can readily calculate interstitial dimensions by geometric techniques associated with crystallography. Assuming a thermally conductive filler particle has an average radius of r for a group of contiguous particles forming a four spheroid intersective interstice, the size of a filler particle capable of filling the interstice is less than or equal to a diameter D given by:

D≤2SQRT(2r2)−2r

In some inventive embodiments, the thermally conductive filler has a bimodal size distribution or a second of the aforementioned thermally conductive filler is size matched to promote interstitial filling of voids between proximal particles of filler by the smaller particles of thermally conductive filler. By way of example, four coplanar 18 micron filler particles packed in an matrix formed from an inventive composition create a 7.4 micron diameter interstice. A smaller filler particle having a mean 5 micron diameter is well suited to fill a 7.4 micron interstitial. One of skill in the art can readily calculate interstitial dimensions by geometric techniques associated with crystallography. Assuming a thermally conductive filler particle has an average radius of r for a group of contiguous particles forming a four spheroid intersective interstice, the size of a filler particle capable of filling the interstice is given by an equation as detailed in the priority application.

While not intending to be bound by a particular theory, it is surmised that interstitial dispersion of small particles within a grouping of larger particles inhibits formation of an inhomogeneous region rich in filler. Inhomogeneous filler regions with comparatively weak interactions with a surrounding cured matrix are believed to promote crack propagation and thereby weaken the resulting article.

Specific ratios of large to small thermally conductive filler particles range from 50 to 80 total weight percent of the thermally conductive filler of the large particle size and 20 to 50 total weight percent of the thermally conductive filler of smaller particle size. In still other embodiments, the ratio of large to small thermally conductive filler particles ranges from 50 to 90 total weight percent of the thermally conductive filler of the large particle size and 10 to 50 total weight percent of the thermally conductive filler of smaller particle size, with the proviso that the formulation contains less than 2 total weight percent of graphite.

To the extent that the aforementioned thermally conductive fillers are also electrically conductive, loading of the thermally conductive fillers are adjusted to retain an electrically resistivity (ρ) of at least 10 Ohm·m. As it is appreciated that electrically resistance can vary in direction and whether measured for the volume or surface, as used herein, p is the minimum value obtained based on ASTM F1529-02.

According to embodiments, the impact modifier operative herein illustratively includes styrenic-block butadiene copolymer modifiers, maleic anhydride terminated polymer, vinyl terminated butyl nitrile, epoxy terminated butyl nitrile, amino terminated butyl nitrile, methyl methacrylate-butadiene-styrene, nitrile rubber, a block copolymer of styrene or alpha methyl styrene and butadiene or hydrogenated butadiene, with high rubber graft having 50 percent rubber or more, ABS, natural rubber, or combinations thereof. It is further appreciated that methyl methacrylate terminated versions of any of the aforementioned are also operative herein as impact modifiers that crosslink to the matrix formed by monomer/oligomer cure. The loading of an impact modifier depends on factors including weight ratio between adhesive Part A and activator Part B, impact modifier molecular weight, and impact modifier modulus. Typical impact modifier loadings range from 1-5 total weight percent for a 1:1, 4:1, or 10:1 inventive formulation. In certain inventive embodiments, the impact modifier is present as a rubber component in combination with a toughening agent, for example, in the form of a core-shell rubber particle. In still other embodiments, the impact modifier is segregated into an activator, Part B of an inventive formulation, yet still serves to modify the failure mode of the cured adhesive. In some inventive embodiments, the impact modifier is present in both the Parts A and Part B.

According to embodiments, the pre-reacted elastomer rubbers operative herein include difunctional ethoxylated bisphenol A metbacrylate, methylmethacrylate-butadiene-styrene-copolymer (MBS), polychloroprene paraffin wax additives, acrylatebutadiene; butadiene; chloroprene; ethylene-propylene; ethylene-propylene-diene; isoprene; isobutylene; isobutylene isoprene (butyl rubber); styrene-butadiene; styrene-isoprene; acrylonitrile-butadiene; acrylonitrile-chloroprene; vinyl-terminated polybutadienes such as vinylpyridine-butadiene, vinylpyridine-styrene-butadiene; carboxylic-styrenebutadiene; chloro-isobutylene-isoprene (chlorobutyl rubber); bromo-isobutylene-isoprene (bromobutyl rubber); dialkysiloxane, polypropylene oxide); polyester urethanes; polyether urethanes; and mixtures thereof. In specific embodiments of the present invention, the pre-reacted elastomer rubbers are present in the adhesive Part A, the activator part B, or a combination thereof. Typical loadings of pre-reacted elastomer rubbers in each part of the formulated inventive adhesive range from 0.05 to 4 total weight percent.

According to embodiments, the organometallic catalyst operative herein includes copper, tin, bismuth, zinc, potassium. In specific embodiments of the present invention, the organometallic catalyst is present in the activator Part B only; however, in some embodiments, the organometallic catalyst is present in both part A and part B. Typical loadings of organometallic catalyst in the total formulated inventive adhesive range from 0 to 0.005 total weight percent.

According to some inventive embodiments, the thixotrope is illustratively includes fumed silica, organoclays, organophilic phyllosilicate, inorganic clays and precipitated silica. A thixotropic agent is present from 0 to 10 percent by weight. In some embodiments, organophilic phyllosilicate additives function as the thixotrope and are defined as the material obtained by the reaction of a phyllosilicate that is completely delaminated colloidally in water and cationic exchanged with an organic onium salt in aqueous suspension followed by subsequent mechanical removal of the water without drying by heating.

According to embodiments, the peroxide catalyst operative herein includes Acid para toluene sulfonyl chloride catalyst, tert-butyl peroxybenzoate aromaticperester peroxide, 1,2 dichlorobenzene peroxide, 1,3 and 1,4-bis(tert-butyl peroxyisopropyl) benzene peroxide. In specific embodiments of the present invention, the peroxide catalyst is present in the adhesive Part A only; however, in some embodiments, the organometallic catalyst is present in both part A and part B. Typical loadings of peroxide catalyst in the total formulated inventive adhesive range from 0.1 to 0.7 total weight percent.

In some exemplary embodiments of the present invention, ultra-high molecular weight polyethylene (UHMW-PE) is present from 1-3 total weight percent upon mixing of Parts A and B, methacrylate is present up to 10 total weight percent, there is no curable monomer present with a flash point at standard temperature and pressure (STP) of less than 65° C. In still other inventive embodiments, a toughening agent is present in Part A, Part B, or in both Parts A and B.

In some inventive embodiments, a polymerization initiator is provided that is a sulfonyl chloride. Sulfonyl chlorides operative herein illustratively include chlorosulfonated polyethylene, tosyl chloride, methanesulfonyl chloride, benzenesulfonyl chloride, C₂-C₁₄ alkylsulfonyl chloride, and C₇-C₁₄ arylsulfonyl chloride, or a combination thereof, where an alkyl is intended to include linear, branched, cyclic, structures, as well as the aforementioned structures with pendant groups therefrom, while aryl groups include diaryls and monoaryls inclusive of pendant groups. A sulfonyl chloride is present in the present invention in Part A in either unprotected or encapsulated form, while a sulfonyl chloride is present in Part B only in encapsulated form. Typical loading of a sulfonyl chloride, if present, ranges from 0 to 1 total weight percent of a combined Part A and Part B, not inclusive of any encapsulant for 1:1, 4:1, or 10:1 volume ratio Part A:Part B. It is appreciated that the sulfonyl chlorides can be used in combination with halogen chain transfer agents, and/or multifunctional chain transfer agents to adjust work time of the resulting formulation. It is appreciated that loadings can be higher if chloro-sulfonated polyethylene (CSPE) is used instead of tosyl chloride due to much higher MW per mole of sulfonyl chloride of CSPE) with CSPE amounts ranging from 0 to 8 total weight percent of a combined Part A and Part B, not inclusive of any encapsulant for 1:1, 4:1, or 10:1 volume ratio Part A:Part B.

An encapsulant operative herein is detailed in U.S. Pat. No. 3,396,116, the details of which are hereby incorporated by reference.

An inventive formulation in some inventive embodiments also includes a toughening agent. A toughening agent is distinguished from impact modifier in the present invention in being resins that are either blended or dissolved and form a miscible blend/solution with the monomers and can significantly improve the performance of cured adhesives at low temperatures such as −40° F. (−40° C.) and at the same time does not cause a negative impact on the performance of cured adhesives at elevated temperatures such as 180° F. whereas core-shell structured impact modifiers that are rubber particle dispersions provide not only excellent impact strength but also non-sag, excellent thixotropic property and improved anti-sliding performance. Toughening agents operative herein illustratively can be chosen from a wide variety of elastomeric materials that form discrete particles or biphasic domains in a continuous resin matrix. For example, pre-reacted particles, butadiene-acrylonitrile copolymer, styrene/ethylene/styrene, alpha-methyl styrene/ethylene/alpha methyl styrene, alpha-methyl styrene/butadiene/alpha methyl styrene, styrene/butadiene/styrene (SBS) copolymers, styrene/isoprene/styrene (SIS) copolymers, styrene/ethylene/butadiene/styrene (SEBS) copolymers, styrene/butadiene (SBR) copolymers, styrene acrylonitrile (SAN), vinyl terminated butadiene co-acrylonitrile, glycidyl methacrylate functionalized butadiene co-acrylonitrile, hydroxy functionalized butadiene, isocyanate functionalized butadiene, amine terminated butadiene, epoxy terminated butadiene, melanized poly-butadiene or -isoprene, or copolymers thereof. U.S. Pat. No. 6,660,805 includes examples of such malenized polymers and copolymers, as well as other pre-reacted materials may be added in particulate form to the resin composition. Typical loading of a toughening agent, if present, ranges from 0 to 4 total weight percent of a combined Part A and Part B. In some inventive embodiments, the toughening agent is present in only one of Part A or Part B, while according to other embodiments, the toughening agent is present in both part A and Part B.

Moreover, reactive liquid polymers (RLP's) also can be incorporated as the toughening component. RLP's contain functional groups, usually on their terminal ends but occasionally as pendant groups and react with the resin in situ to form elastomeric domains. Examples of RLP's include, without limitation, vinyl terminated butadiene acrylonitrile (VTBN), carboxylterminated butadiene acrylonitrile (CTBN), amine-terminated butadiene acrylonitrile (ATBN), hydroxyl-terminated butadiene acrylonitrile (HTBN), epoxy-terminated butadiene acrylonitrile (ETBN), mercapto-terminated butadiene acrylonitrile (MTPN), vinyl-terminated butadiene (VTB), maleinized butadiene, phenoxy-terminated butadiene acrylonitrile (PTBN). In specific embodiments of the present invention, the toughening agent includes ultra-high molecular weight polyethylene (UHMW-PE), chloro-sulphonated polyethylene, neoprene, copolymers of ethylene acrylic elastomer, poly (methyl methacrylate)-grafted rubber, butadiene styrene acrylonitrile copolymer or combinations thereof. It is further appreciated that methyl methacrylate terminated versions of any of the aforementioned are also operative herein as toughening agents that cross link to the matrix formed by monomer/oligomer cure.

In order to formulate an inventive adhesive formulation that achieves high strength without the need for a separate surface treatment prior to application of an inventive formulation, an adhesion promoter is provided within an inventive formulation, according to some embodiments. The adhesion promoter facilitates adhesion of a fully cured formulation of various substrates including galvanized substrates. An adhesion promoter is readily formulated into either an adhesive Part, an activator Part, or both Parts of an inventive formulation. In specific embodiments, the adhesion promoter is found only in the adhesive Part. Specific adhesion promoters operated in an inventive formulation illustratively a phosphate ester, a monofunctional phosphate, a difunctional phosphate, polymeric phosphate functionalized polymer, a (meth)acrylic acid, polymeric material with organic acid functionality, maleic acid, acid functionalized polymer such a maleinized polybutadiene, citric di- or tri-methacrylates, polymethacrylated oligomaleic acid, poly methacrylated polymaleic acid, poly methacrylated poly methacrylic acid, a silane, or a combination thereof. Silane adhesion promoters operative herein illustratively include: 3-aminopropyltrimethoxysilane, 3-aminopropyltriethoxysilane, 3-glycidoxypropyltrimethoxysilane, 3-glycidoxypropyltriethoxysilane, (3-glycidoxypropyl) bis(trimethylsiloxy)methylsilane, (3-glycidoxypropyl)methyldiethoxysilane, (3-glycidoxypropyl) dimethylethoxysilane, (3-glycidoxypropyl)methyldimethoxysilane, methacryloxymethyltriethoxysilane, methacryloxymethyltrimethoxysilane, methacryloxypropyldimethylethoxysilane, methacryloxypropyldimethylmethoxysilane, methacryloxypropyltrimethoxysilane ethacryloxypropylmethyldimethoxysilane, methacryloxypropyltriethoxysilane, methoxymethyltrimethylsilane, 3-methoxypropyltrimethoxysilane, 3-methacryloxypropyldimethylchlorosilane, methacryloxypropylmethyldichlorosilane, methacryloxypropyltrichlorosilane, 3-isocyanatopropyldimethylchlorosilane, 3-isocyanatopropyltriethoxysilane, bis(3-triethoxysilylpropyl)tetrasulfide, and combinations thereof. Typical loadings of adhesion promoter in an inventive formulation are from 0 to 1 total weight percent in a 1:1, 4:1, or 10:1 adhesive:activator formulation.

According to some embodiments, an anti-oxidant is present in an adhesive and illustratively includes hydroquinone (HQ), butylated hydroxytoluene (BHT), 1,4-naphtoquinone, 2,6-Di-tert-butyl-4-(dimethylaminomethyl)phenol, (2,2,6,6-Tetramethylpiperidin-1-yl)oxyl or commonly known as TEMPO, 4-hydroxy-TEMPO or TEMPOL, butylated hydroxyanisole, 2,6-di-t-butyl cresol, 2,2′-methylene bis(6-t-butyl-4-methyl phenol), 2,2′-thio bis(6-t-butyl-4-methyl phenol), tert-butyl hydroquinone, di-tert-butyl hydroquinone, di-tert-amyl hydroquinone, methyl hydroquinone, p-methoxy phenol, tetrakis[methylene-3-(3′,5′-di-tert-butyl-4′-hydroxyphenyl)propionate]methane, N-(2-aminoethyl)-3-[3,5-bis(tert-butyl)-4-hydroxyphenyl]propanamide, 5,7-di-tert-butyl-3-(3,4-dimethylphenyl)-3H-benzofuran-2-one, dilauryl thiodipropionate, dimyristyl thiodipropionate, tris(nonylphenyl) phosphite, and combinations thereof. Typical loadings of an antioxidant in an inventive formulation are from 0 to 1 total weight percent of in a 1:1, 4:1, or 10:1 adhesive:activator formulation.

A polymerization accelerator present in an activator Part B is limited only by the desired kinetics of free radical polymerization desired and compatibility with other inventive composition components. Accelerators operative herein illustratively include dimethylamino pyridine; polyethyleneimine, N,N-dimethylaniline, modified dihydropyridines such as 3,5-diethyl-1,2-dihydro-1-phenyl-2-propylpyridine, 2-methylimidazole, 2-hydroxyethyl p-toluidine, ethanolamine, diethanolamine, diethylethanolamine, methyldiethanolamine, butyldiethanolamine, diethylamine, triethylamine, n-butylamine, 2,2-bipyridine, 1,10-phenanthroline, ammonia, alkylidene malonate, 6-iminomalonate, ethylazan, phenylamine, benzylamine, 1-benzofuran-2-amine, 4-quinolylamine, pentane-1,2,5-triamine, benzene-1,2,4,5-tetramine, bis(2-chloroethyl)amine, butyl(ethyl)methylamine, (2-chloroethyl)(propyl)amine, hexane-1-imine, isopropylidene amine, ethane-1,2-diimine, carbodiimide, o-acetylhydroxyamine, o-carboxyhydroxylamine, hydroxylamine-o-sulfonic acid, o-hydroxyaniline, phenylpropanolamine hydrochloride, catecholamine, indoleamine, or polyacrylamine and combinations thereof. Typical loading of an accelerator in an inventive formulation is from 0 to 1 total weight percent of in a 1:1, 4:1, or 10:1 adhesive:activator formulation. Without intending to be bound to a particular theory, the accelerator is believed to react to decompose the organic peroxide and increase the cure rate of the adhesive.

An inventive formulation in certain embodiments of the adhesive also includes various body fillers that are flame resistant and/or fire retardant with good application characteristics. An inorganic hydrate filler operative herein includes aluminum trihydrate (ATH); a geologic source thereof, such as gibbsite; huntite (largely Mg₃Ca(CO₃)₄); hydromagnesite (largely Mg₅(CO₃)₄(OH)₂·4H₂O); AlN; Al₂O₃/HBNNT; sepiolite clay (Mg₄Si₆O₁₅(OH)₂·6H₂O); SbO₃; or combinations thereof. With the proviso that huntite is present in mixtures with hydromagnesite. It is appreciated that the surface energy of the inorganic hydrate filler is reduced by treating the inorganic hydrate filler with a silane to render the filler more compatible with the resin. A silane, if present, is typically present in an amount of from 0.1 to 1 weight percent of the inorganic hydrate filler and if present is included as part of the weight of the hydrate filler. In specific inventive embodiments, the flame resistant and/or fire retardant filler is only alumina trihydrate (ATH), AlN, or Al₂O₃/HBNNT. The inorganic hydrate filler releases water of hydration upon heating associated with a fire thereby providing a cooling effect to inhibit combustion. The flame resistance and/or fire retardancy properties of the inventive body filler are formulated for use in embodiments of the adhesive while maintaining fire safety ratings.

In some inventive embodiments, a surprisingly effective char layer 0.5 to 3% by weight of the ATH being sepiolite clay. As a result, V1 performance of a given inventive material is enhanced by reducing self-extinguishment times to 20 seconds or even less time, or the material even achieves V0 classification.

Embodiments of the inventive adhesive that contain ATH, AlN, or Al₂O₃/HBNNT as an inorganic hydrate filler show good application performance and, in some cases, match performance of a control adhesive without ATH AlN, or Al₂O₃/HBNNT. Inorganic hydrate fillers can be formulated to achieve different working times, 4-30 minutes, depending on specific applications.

Embodiments of the inventive adhesive containing ATH burned for a very short time of less than 20 seconds, and then the fire was self-extinguished to satisfy V1 classification. In specific inventive embodiments 8-15/48-61 total weight percent % Al₂O₃ to ATH to produces a fully flame retardant material at low density.

It has also been surprisingly found that 22-38/22-38 total weight % loading of AlN/ATH produce a fully V0 flame retardant material, where the same formulation using Al₂O₃ requires greater than 45% ATH to produce a fully V0 system. At like amounts, 22-38 total weight % ATH, the Al₂O₃ cured material can only pass UL-94-V1 when ATH is the only flame-retardant component.

In certain inventive embodiments, when SbO₃ is present, conventional brominate flame retardant is also present and the combination affords surprisingly good fire retardancy properties relative to SbO₃ alone.

An inventive formulation in certain embodiments also includes various additive such as chelating agents, corrosion inhibitors, thickeners, pigments, thixotropic agents, plasticizers, viscosity regulators, and combinations thereof. Such additives are limited only by the requirement of compatibility with the other components of an inventive formulation. Such additives are provided to balance or otherwise modify at least one property of an inventive formulation as to handling, storage, cure rate, or adhesive properties. Typical loading of each additive in an inventive formulation is independently from 0 to 5 total weight percent of in a 1:1, 4:1, or 10:1 adhesive:activator formulation.

Typical component amounts for an inventive adhesive are provided in Tables 1A and 1B for Parts A and B, respectively.

Tables 1A and 1B. Typical component amounts for adhesive (Part A) and activator (Part B), where amounts are given in weight percentages unless otherwise noted:

TABLE 1A
ADHESIVE (Part-A)
Adhesive Part A Composition:

| Component: | Amount: |
|---|---|
| Monomers | 7-21 |
| Filler | 40-90 |
| Impact modifier | 1-20 |
| Pre-reacted elastomer rubbers | 0.05-4 |
| Organometallic catalyst | 0 |
| Thixotrope | 0-10 |
| Peroxide curing agent | 0.1-3 |
| Polymerization initiator | 0-1 |
| Adhesion promoter | 0-2 |
| Anti-oxidant | 1-3 |
| Polymerization accelerator | 0.1-3 |
| Optional additives each up to 5% | 0-remainder |

TABLE 1B
ACTIVATOR (Part B)
Activator Part B Composition:

| Component: | Amount: |
|---|---|
| Monomer | 8-22 |
| Filler | 40-90 |
| Impact modifier | 1-20 |
| Pre-reacted elastomer rubbers | 0.3-3 |
| Organometallic catalyst | 0-0.2 |
| Thixotrope | 0-10 |
| Peroxide catalyst | 0.1-2 |
| Polymerization initiator | 0-1 |
| Toughening agent | 0-4 |
| Adhesion promoter | 0-1 |
| Anti-oxidant | 0-2 |
| Polymerization accelerator | 0-1 |
| Optional additives each up to 5% | 0-remainder |

A process is provided for producing an adhesive formulation produced by free radical polymerization that bonds well to the aforementioned substrates. An inventive formulation is a two-part formulation that is either premixed to initiate a time period pot life, or alternatively the two parts are co-applied to a substrate under conditions for polymerization to occur between the various monomers. In specific inventive embodiments, polymerization occurs at 24° C. in ambient atmosphere on other embodiments, polymerization is initiated by energy inputs such as heating, ultraviolet radiation exposure or other free radical formation mechanisms. In certain inventive embodiments in which the adhesive Part A, and activator Part B are present in a 1:1, 4:1, or 10:1 volumetric ratio ±10%, storage stability of more than 180 days at 23° C. is obtained. Typical viscosities of Part A and B are each independently between 20,000 and 500,000 cPs. In some inventive embodiments the separate Part A and Part B viscosities are within ±50 percent of one another to facilitate mixing there between.

Regardless of the form of an inventive formulation, upon induction of pot life for the formulation, the formulation is present in simultaneous contact with two or more substrates with the substrates held in contact with the curing inventive formulation for an amount of time sufficient to achieve a bond between the substrates. An inventive formulation is well-suited for bonding galvanized substrates, cold rolled steel, aluminum, PVC, ABS, mild steel, vinyl polymers, wood, and fiberglass. Two such substrates can be brought together to form various adjoined structures such as a lap joint, butt joint, corner joint, edge joint, and T-joint. In still other embodiments, an inventive formulation is applied to a single substrate and allowed to cure to form a coating that offers substrate protection or is operative as a primer for subsequent material applications. As an inventive formulation cures through a free radical mechanism, an inventive formulation can be applied to a variety of thicknesses and still achieve polymerization throughout. Typical thicknesses of an inventive formulation between substrates range from 0.001-25 mm.

An inventive adhesive in some embodiments rapidly builds strength to facilitate handling as measured by lap shear on mild steel at a thickness of 5 mm that reaches a strength of 0.34 MPa in between 30 and 35 minutes and 3 to 5 MPa by 50 minutes.

According to embodiments, the inventive adhesive has a thermal conductivity measurement of 0.8 to 4 W/m/K. This cured material allows the user to not only adhere to their substrates, but also dissipate thermal energy in the process, be nonflammable and nontoxic.

### Example 1

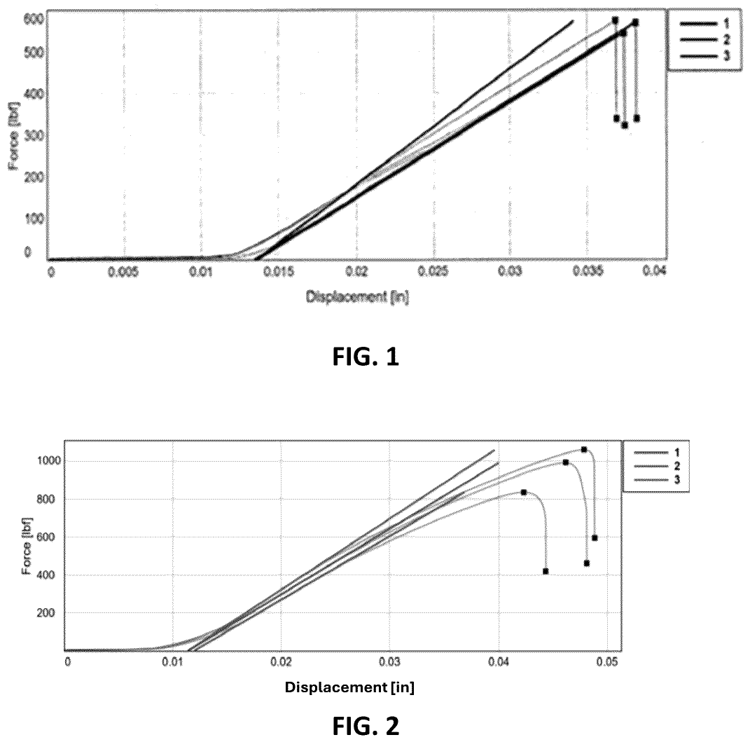

An inventive adhesive formulation including 85% thermally conductive filler is applied and cured between two aluminum substrates to form three identical samples. The samples were subjected to ASTM D1002 lap shear testing with lap shear 0.05″/min. The results are shown in the graph of FIG. 1 and the following Table 2. The mean lap shear strength of the inventive adhesive formulation including 85% thermally conductive filler is 782 PSI on aluminum 6006.

TABLE 2
Lap shear data.

| | | | Lap shear | Young's | Displacement | Max. |
|---|---|---|---|---|---|---|
| | Max. Load | Area | strength | modulus | at max load | extension |
| Sample | (lbf) | (in²) | (psi) | (psi) | (in) | (in) |
| 1 | 569.69 | 0.61 | 929.35 | 147800.83 | 0.04 | 0.04 |
| 2 | 544.66 | 0.78 | 697.38 | 116075.28 | 0.04 | 0.04 |
| 3 | 573.57 | 0.79 | 725.12 | 138872.74 | 0.04 | 0.04 |
| Mean | 562.64 | 0.73 | 783.95 | 134576.29 | 0.04 | 0.04 |
| St. Dev. | 15.69 | 0.10 | 126.68 | 16770.75 | 0.00 | 0.00 |

### Example 2

An inventive adhesive formulation including 75% thermally conductive filler is applied and cured between two aluminum substrates. The sample was subjected to ASTM D1002 lap shear testing with lap shear 0.05″/min. The results are shown in the graph of FIG. 2 and the related Table 3 below. The mean lap shear strength of the inventive adhesive formulation including 85% thermally conductive filler is 1845 PSI on aluminum.

TABLE 3
Lap shear data.

| | | | Lap shear | Young's | Displacement | Max. |
|---|---|---|---|---|---|---|
| | Max. Load | Area | strength | modulus | at max load | extension |
| Sample | (lbf) | (in²) | (psi) | (psi) | (in) | (in) |
| 1 | 1057.06 | 0.50 | 2122.62 | 295799.95 | 0.05 | 0.05 |
| 2 | 990.14 | 0.50 | 1988.23 | 273419.37 | 0.05 | 0.05 |
| 3 | 834.84 | 0.59 | 1424.64 | 224945.54 | 0.04 | 0.04 |
| Mean | 960.68 | 0.53 | 1845.16 | 264721.62 | 0.05 | 0.05 |
| St. Dev. | 114.00 | 0.05 | 370.33 | 36219.13 | 0.00 | 0.00 |

### Example 3

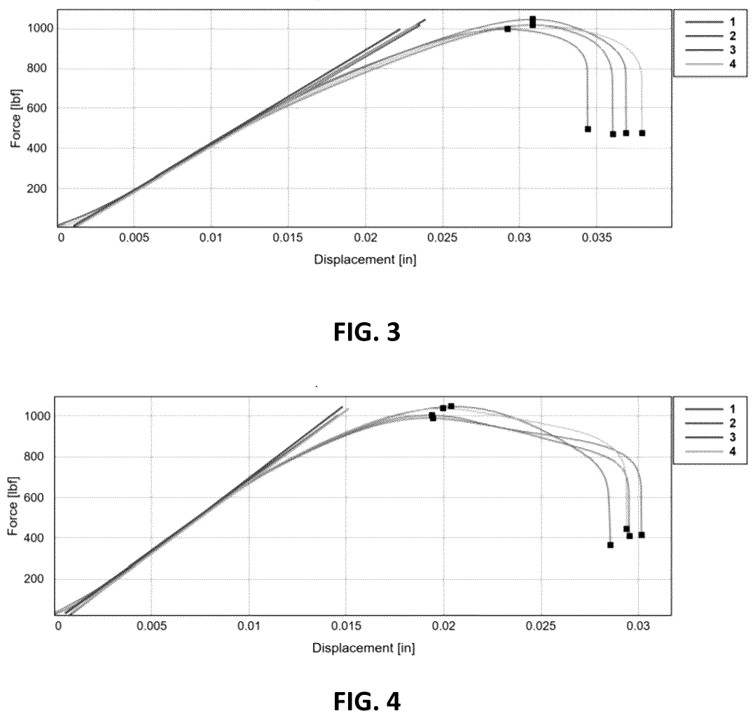

An inventive adhesive formulation including 74% thermally conductive filler of DG-TC-ADH is applied and cured between two aluminum 6006 substrates. The sample was subjected to ASTM D1002 lap shear testing with lap shear 0.05″/min. The results are shown in the graph of FIG. 3 and the related Table 4 below. The mean lap shear strength of the inventive adhesive formulation including 7400 thermally conductive filler is 1019 PSI on aluminum 6006.

TABLE 4
Lap shear data.

| | | | Lap shear | Young's | Displacement | Max. |
|---|---|---|---|---|---|---|
| | Max. Load | Area | strength | modulus | at max load | extension |
| Sample | (lbf) | (in²) | (psi) | (psi) | (in) | (in) |
| 1 | 995.49 | 0.53 | 1892.56 | 349313.14 | 0.03 | 0.03 |
| 2 | 1016.67 | 0.53 | 1932.84 | 334904.16 | 0.03 | 0.04 |
| 3 | 1044.69 | 0.55 | 1906.38 | 325488.79 | 0.03 | 0.04 |
| 4 | 1017.57 | 0.55 | 1856.88 | 328269.22 | 0.03 | 0.04 |
| Mean | 1018.61 | 0.54 | 1897.16 | 334493.83 | 0.03 | 0.04 |
| St. Dev. | 20.16 | 0.01 | 31.63 | 10639.81 | 0.00 | 0.00 |

### Example 4

An inventive adhesive formulation including 74% thermally conductive filler of DG-TC-ADH is applied and cured between two SS304 (type 304 stainless steel) substrates. The sample was subjected to ASTM D1002 lap shear testing with lap shear 0.05″/min. The results are shown in the graph of FIG. 4 and the related Table 5. The mean lap shear strength of the inventive adhesive formulation including 80% thermally conductive filler is 1020 PSI on SS304.

TABLE 5
Lap shear data.

| | | | Lap shear | Young's | Displacement | Max. |
|---|---|---|---|---|---|---|
| | Max. Load | Area | strength | modulus | at max load | extension |
| Sample | (lbf) | (in²) | (psi) | (psi) | (in) | (in) |
| 1 | 1046.81 | 0.56 | 1852.76 | 509102.42 | 0.02 | 0.03 |
| 2 | 1004.17 | 0.56 | 1777.29 | 482485.76 | 0.02 | 0.03 |
| 3 | 990.49 | 0.54 | 1841.06 | 507153.02 | 0.02 | 0.03 |
| 4 | 1037.33 | 0.57 | 1813.51 | 485042.94 | 0.02 | 0.03 |
| Mean | 1019.70 | 0.56 | 1821.15 | 495946.03 | 0.02 | 0.03 |
| St. Dev. | 26.17 | 0.02 | 33.56 | 14127.32 | 0.00 | 0.00 |

### Example 5

Formulations of the inventive adhesive are prepared and tested for thermal conductivity. The results are shown in Table 6 below.

TABLE 6
Thermal conductivity of inventive adhesives with
varying amounts of thermally conductive filler
Thermal Conductivity Acrylics

| | Material | Filler (%) | TC (w/m*K) |
|---|---|---|---|
| 1 | BMA | 0 | 0.2 |
| 2 | TC-1 | 75 | 1.1 |
| 3 | TC-2 | 75 | 1.2 |
| 4 | TC-3 | 85.7 | 2.3 |
| 5 | TC-4 | 85.7 | 2.8 |
| 6 | TC-5 | 90 | 3.1 |
| 7 | TC-6 | 90 | 3.5 |

### Example 6

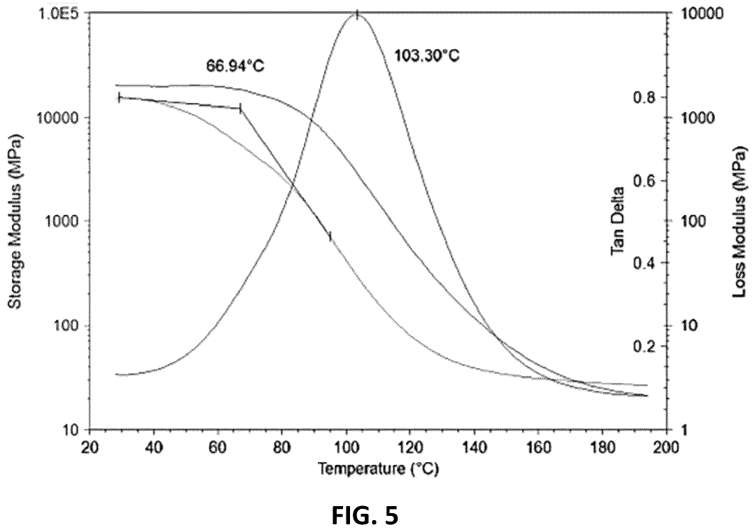

Dynamic mechanical analysis (DMA) tests are conducted on an inventive adhesive formulation including 85% thermally conductive filler. The results are shown in the graph of FIG. 5. The DMA results show that the cured material is not brittle and has a very high storage modulus capability for highly filled acrylic adhesive. This indicates that although highly filled, this cured material is not brittle. This is also important since most of the impact modifier is removed, which is the ingredient that gives this cured material its more elastic properties, lowering the brittleness.

The results also show that the addition of thermally conductive fillers such as HBN, helped to lower the flammability of the formulation. This means that only a small addition of around 4-5% will significantly improve flame resistance.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A two-part adhesive formulation comprising:
an adhesive Part A comprising: a Part A methacrylate monomer of benzyl methacrylate, methyl methacrylate, isobornyl methacrylate, methacrylic acid, tetrahydrofurfuryl methacrylate, tetrahydrofurfuryl acrylate, 2-hydroxyethyl methacrylate phosphate, 2-hydroxypropyl methacrylate (HPMA), lauryl methacrylate or a combination thereof, and a Part A thermally conductive filler; and
an activator Part B comprising: a Part B methacrylate monomer benzyl methacrylate, methyl methacrylate, isobornyl methacrylate, methacrylic acid, tetrahydrofurfuryl methacrylate, tetrahydrofurfuryl acrylate, 2-hydroxyethyl methacrylate phosphate, 2-hydroxypropyl methacrylate, lauryl methacrylate or a combination thereof, and Part B thermally conductive filler;
wherein impact modifier, an organometallic catalyst, and a peroxide catalyst is each present in at least one of said Part A and said Part B or added thereto as additional components.

2. The formulation of claim 1 wherein said Part A monomer, or said Part B monomer each independently further comprises at least one secondary monomer of: lauryl methacrylate, hydroxyethyl methacrylate, 2-ethylhexyl methacrylate, and trimethylol propane trimethacrylate, benzyl 2-methylpent-2-enoate, benzyl (E)-2-methylhex-2-enoate, benzyl (2E)-2-ethenylpenta-2,4-dienoate, 5-O-benzyl 1-O-methyl (E)-pent-2-enedioate, benzyl (E)-2-methyl-4-prop-2-enoxybut-2-enoate, benzyl prop-2-enoate, methyl (E)-2-methylidene-9-phenylmethoxynon-3-enoate, benzyl (E)-3-methoxy-2-methylprop-2-enoate, ethyl 2-methyl-5-phenylmethoxypent-2-enoate, benzyl (2E)-2-methylhexa-2,5-dienoate, 4-phenylmethoxybutyl 2-methylprop-2-enoate, benzyl (2E,4E)-5-fluoro-2-methylhexa-2,4-dienoate, benzyl (2E)-2-ethenyl-3-methylpenta-2,4-dienoate, fluoro benzyl methacrylate, 2-(perfluorooctyl)ethyl acrylate, (perfluoroheptyl)methyl methacrylate, 2-(N-ethylperfluorooctasulfoamido)ethyl acrylate, 2-(perfluorohexyl)ethyl methacrylate, 2-(perfluoroisononyl)ethyl acrylate, or a combination thereof.

3. The formulation of claim 1 wherein said Part A thermally conductive filler and said Part B thermally conductive filler is each independently at least one of expanded graphite, coke graphite, flake graphite, synthetic graphite, hexagonal boron nitride, zinc oxide, magnesium oxide, aluminum oxide (spherical, roundish, tabular), silane treated and non-silane treated aluminum oxide, aluminum hydroxide, alumina (Al₂O₃), alumina trihydrate (ATH), aluminum nitride (AlN), Al₂O₃/hexagonal boron nitride, and combinations thereof.

4. The formulation of claim 1 wherein said Part A conductive filler and said Part B conductive filler is present from 70-90 total weight percent of said Part A and said part B, respectively.

5. The formulation of claim 1 wherein at least one of said part A conductive filler or said part B conductive filler has a ratio of from 50 to 80 total weight percent of the thermally conductive filler of a large particle size and 20 to 50 total weight percent of the thermally conductive filler of smaller particle size.

6. The formulation of claim 1 wherein at least one of said part A thermally conductive filler or said part B thermally conductive filler has a ratio of large to small thermally conductive filler particles from 50 to 90 total weight percent of the thermally conductive filler of the large particle size and 10 to 50 total weight percent of the thermally conductive filler of smaller particle size, with the proviso that the formulation contains less than 2 total weight percent of a graphite.

7. The formulation of claim 1 further comprising a Part A pre-reacted elastomer rubber or reactive liquid polymer or a Part B pre-reacted elastomer rubber or reactive liquid polymer.

8. The formulation of claim 7 wherein said Part A pre-reacted elastomer rubber is present from 0.05 to 4 total weight percent of said Part A; and
wherein said Part B pre-reacted elastomer rubber is present from 0.03 to 3 total weight percent of said Part B.

9. The formulation of claim 1 wherein said impact modifier is present from 1 to 5 total weight percent in a fully formulated adhesive upon mixture of said Part A with said Part B.

10. The formulation of claim 1 further comprising a thixotrope, wherein said thixotropic is an organophilic phyllosilicate additive is present from 1 to 10 total weight percent in a fully formulated adhesive upon mixture of said Part A with said Part B.

11. The formulation of claim 1 wherein said peroxide catalyst is present from 0.1 to 0.7 total weight percent in a fully formulated adhesive upon mixture of said Part A with said Part B.

12. The formulation of claim 1 further comprising one or more of:
a polymerization initiator present from 0 to 1 total weight percent in a fully formulated adhesive upon mixture of said Part A with said Part B;
a toughening agent present from 0 to 4 total weight percent in a fully formulated adhesive upon mixture of said Part A with said Part B;
an adhesion promoter present from 0 to 2 total weight percent in a fully formulated adhesive upon mixture of said Part A with said Part B;
an antioxidant present from 0 to 2 total weight percent in a fully formulated adhesive upon mixture of said Part A with said Part B; and
a polymerization accelerator present from 0 to 1 total weight percent in a fully formulated adhesive upon mixture of said Part A with said Part B.

13. The formulation of claim 1 further comprising a body filler present in an amount to impart V0 or V1 flame rating to a cured material of the formulation.

14. The formulation of claim 13 wherein the body filler is ATH, gibbsite, huntite, hydromagnesite, AlN, Al₂O₃/HBNNT, sepiolite clay, SbO₃, or combinations thereof.

15. The formulation of claim 13 wherein 8-15/48-61 total weight percent % Al₂O₃/ATH or 22-38/22-38 total weight % loading of AlN/ATH is present.

16. The formulation of claim 1 wherein ATH is present and further comprising sepiolite clay present in an amount of 0.5 to 3% by weight of the ATH.

17. A two-part adhesive formulation consisting essentially of:
an adhesive Part A comprising: a Part A methacrylate monomer of benzyl methacrylate, methyl methacrylate, isobornyl methacrylate, methacrylic acid, tetrahydrofurfuryl methacrylate, tetrahydrofurfuryl acrylate, 2-hydroxyethyl methacrylate phosphate, 2-hydroxypropyl methacrylate (HPMA), lauryl methacrylate or a combination thereof, and a Part A thermally conductive filler; and
an activator Part B consisting of peroxide catalyst, and optionally at least one of a Part B thermally conductive filler, a plasticizer, or an impact modifier.

18. A process of applying the two-part adhesive formulation of claim 1 to a substrate, the process comprising:
mixing together said adhesive part A and said activator part B;
combining said impact modifier, said organometallic catalyst, and said peroxide catalyst with said mixed adhesive part A and activator part B if not already present in said adhesive part A and said activator part B;
applying said adhesive mixture to the substrate; and
allowing said adhesive mixture to cure an adhesive.

19. The process of claim 18 wherein the volume ratio of adhesive Part A to activator Part B is from 1:1±0.10% to 10:1±0.10%.

20. The process of claim 18 further comprising fixturing in a fixture the substrate and said second substrate in a joint position and in simultaneous contact with said mixture for a period of time between 5 and 180 minutes during the free-radical cure and then releasing the substrate and the second substrate from the fixture.
